(19) United States
(12) Patent Application Publication
(10) Pub. No.: US 2023/0094093 A1
(43) Pub. Date: Mar. 30, 2023

(54) METHOD AND SYSTEM FOR PROVIDING PERSONAL TRANSPORTATION SERVICE USING AUTONOMOUS VEHICLE

(71) Applicant: ELECTRONICS AND TELECOMMUNICATIONS RESEARCH INSTITUTE, Daejon (KR)

(72) Inventor: Hongki CHA, Daejeon (KR)

(21) Appl. No.: 17/952,028

(22) Filed: Sep. 23, 2022

(30) Foreign Application Priority Data
Sep. 24, 2021 (KR) 10-2021-0126611
Sep. 23, 2022 (KR) 10-2022-0120951

(51) Int. Cl. B60W 60/00; G06Q 50/30

(52) U.S. Cl. CPC B60W 60/00253; G06Q 50/30; B60W 2556/10; B60W 2530/201

(57) ABSTRACT

A method and a system for providing a personal transportation service using an autonomous vehicle, including: receiving a request for the personal transportation service from a terminal of a user; analyzing a call pattern of the user for the autonomous vehicle; and determining a recommended autonomous vehicle to provide the personal transportation service to the user based on the analysis result of the call pattern are provided.

### CROSS-REFERENCE TO RELATED APPLICATION

This application claims priority to and the benefit of Korean Patent Application No. 10-2021-0126611 filed in the Korean Intellectual Property Office on Sep. 24, 2021, and Korean Patent Application No. 10-2022-0120951 filed in the Korean Intellectual Property Office on Sep. 23, 2022, the entire contents of which are incorporated herein by reference.

### BACKGROUND OF THE INVENTION

### (a) Field of the Invention

This description relates to a method and system for providing personal transportation service using autonomous vehicle.

### (b) Description of the Related Art

This description relates to a method and apparatus for providing an on-demand service using an autonomous vehicle. Automobile manufacturers and autonomous driving platform developers around the world are conducting trial runs of autonomous vehicles. If autonomous driving technology of level 4 or higher (based on SAE J3016 standard) is developed in the future, it is expected that the autonomous vehicles that do not require driver intervention will rapidly spread and services related to the autonomous vehicles will be developed and distributed.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments provide a personal transport system using an autonomous vehicle.

Embodiments provide a method for providing a personal transportation service using an autonomous vehicle.

According to an embodiment, a personal transport system is provided. In such embodiment, the system includes: a processor, a memory, and a communication device, wherein the processor executes a program stored in the memory to perform: receiving a request for a personal transportation service using an autonomous vehicle from a terminal of a user; analyzing a call pattern of the user for the autonomous vehicle; and determining a recommended autonomous vehicle to provide the personal transportation service to the user based on the analysis result of the call pattern.

In an embodiment, when the processor performs the analyzing a call pattern of the user for the autonomous vehicle, the processor may perform: querying a call history of the user and an idle autonomous vehicle around a call location of the user; and analyzing the call pattern based on the call history and the idle autonomous vehicle.

In an embodiment, when the processor performs the analyzing a call pattern of the user for the autonomous vehicle, the processor may further perform querying a favorite list of the user for the autonomous vehicle, and the favorite list may include an autonomous vehicle and/or an autonomous driving operating system for the autonomous vehicle preferred by the user.

In an embodiment, when the processor performs the analyzing the call pattern based on the call history and the idle autonomous vehicle around the call location, the processor may perform analyzing the call pattern based on the favorite list, the call history, and the idle autonomous vehicle around the call location.

In an embodiment, when the processor performs the receiving a request for a personal transportation service using an autonomous vehicle from a terminal of a user, the processor may perform receiving a search request for an autonomous vehicle from the terminal, and the search request may include at least one of a name, a size, a type, characteristics, a style, a shape, and a color of the autonomous vehicle.

In an embodiment, the processor may execute the program to further perform transmitting at least one available autonomous vehicle to the terminal in response to the search request, and the at least one available autonomous vehicle may be listed in an order of matching accuracy for search criteria of the user or in an order close to a current location or the calling location of the user.

In an embodiment, the processor may execute the program to further perform determining a waiting route for each autonomous vehicle based on the analysis result of the call pattern.

In an embodiment, the processor may execute the program to further perform: receiving a request for the waiting route from an idle autonomous vehicle without a passenger and within which no call has been received; and transmitting the waiting route determined based on the analysis result of the call pattern to the idle autonomous vehicle.

In an embodiment, the recommended autonomous vehicle may include an idle vehicle with no passengers or a scheduled idle vehicle for which a passenger is about to disembark.

According to another embodiment, a method of providing a personal transportation service using an autonomous vehicle is provided. In such embodiment, the method includes: receiving a request for the personal transportation service from a terminal of a user; analyzing a call pattern of the user for the autonomous vehicle; and determining a recommended autonomous vehicle to provide the personal transportation service to the user based on the analysis result of the call pattern.

In an embodiment, the analyzing of the call pattern may include; querying a call history of the user and an idle autonomous vehicle around a call location of the user; and analyzing the call pattern based on the call history and the idle autonomous vehicle.

In an embodiment, the analyzing of the call pattern may further include querying a favorite list of the user for the autonomous vehicle, and the favorite list may include an autonomous vehicle and/or an autonomous driving operating system of the autonomous vehicle preferred by the user.

In an embodiment, the analyzing the call pattern based on the call history and the idle autonomous vehicle may include: analyzing the call pattern based on the favorite list, the call history, and the idle autonomous vehicle. In an embodiment, the receiving the request for the personal transportation service may include receiving a search request for an autonomous vehicle from the terminal, and the search request may include at least one of a name, a size, a type, a characteristics, a style, a shape, and a color of the autonomous vehicle.

In an embodiment, the method may further include transmitting at least one available autonomous vehicle to the terminal in response to the search request, and the at least one available autonomous vehicle may be listed in an order of matching accuracy for search criteria or in an order close to a current location or the calling location of the user.

In an embodiment, the method may further include determining a waiting route for each autonomous vehicle based on the analysis result of the call pattern.

In an embodiment, the method may further include: receiving a request for the waiting route from an idle autonomous vehicle without a passenger and within which no call has been received; and transmitting the waiting route determined based on the analysis result of the call pattern to the idle autonomous vehicle.

In an embodiment, the recommended autonomous vehicle may include an idle vehicle without a passenger or a scheduled idle vehicle for which a passenger is expected to disembark.

### BRIEF DESCRIPTION OF THE DRAWINGS

FIG. 1 is a block diagram illustrating functions of a terminal of a user according to an embodiment.

FIG. 2 is a drawing illustrating a personal transport system according to an embodiment.

FIG. 3 is a block diagram illustrating an autonomous vehicle according to an embodiment.

FIG. 4 is a flowchart illustrating a method for providing a personal transportation service through an autonomous vehicle according to an embodiment.

FIG. 5 is a flowchart illustrating a method for providing a personal transportation service through an autonomous vehicle according to another embodiment.

FIG. 6 is a flowchart illustrating a method for determining a waiting route of an autonomous vehicle according to an embodiment.

FIG. 7 is a block diagram illustrating a personal transport system according to another embodiment.

### DETAILED DESCRIPTION OF THE EMBODIMENTS

In the following detailed description, only certain embodiments of the present invention have been shown and described in detail with reference to the accompanying drawing, simply by way of illustration. However, the present disclosure may be implemented in various different forms and is not limited to the embodiments described herein. Further, in order to clearly describe the description in the drawing, parts not related to the description are omitted, and similar reference numerals are attached to similar parts throughout the specification.

Throughout the specification, a terminal may be called user equipment (UE), mobile station (MS), a mobile terminal (MT), an advanced mobile station (AMS), a high reliability mobile station (HR-MS), a subscriber station (SS), a portable subscriber station (PSS), an access terminal (AT), a machine type communication device (MTC device), and the like and may also include all or some of the functions of the MS, the MT, the AMS, the HR-MS, the SS, the PSS, the AT, the UE, the MTCH device, and the like.

In this specification, unless explicitly described to the contrary, the word “comprises”, and variations such as “including” or “containing”, will be understood to imply the inclusion of stated elements but not the exclusion of any other elements.

In this specification, expressions described in singular can be interpreted as singular or plural unless explicit expressions such as “one” or “single” are used.

As used herein, “A or B”, “at least one of A and B”, “at least one of A or B”, “A, B, or C”, “at least one of A, B, and C”, and “at least one of A, B, or C” each may include any one of, or all possible combinations of, items listed together in the corresponding one of the phrases.

In this specification, “and/or” includes all combinations of each and at least one of the mentioned elements.

In this specification, terms including ordinal numbers such as first and second may be used to describe various configurations elements, but the elements are not limited by the terms. The terms may be only used to distinguish one element from another element. For example, a first element may be named a second element without departing from the right range of the present disclosure, and similarly, a second element may be named a first element.

In the flowchart described with reference to the drawings in this specification, the order of the operations may be changed, several operations may be merged, certain operations may be divided, and specific operations may not be performed.

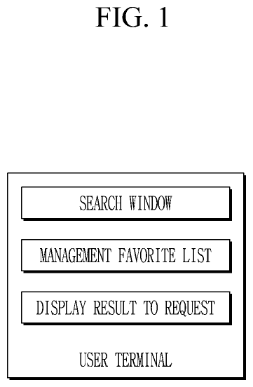

FIG. 1 is a block diagram illustrating functions of a terminal of a user according to an embodiment.

In an embodiment, a user may request a personal transportation service using an autonomous vehicle 200 (or an ADS-DV(Automated Driving System-Dedicated Vehicle)) to the personal transport system 100 through the terminal of a user. A request for the personal transportation service may be initiated by a user requesting a call for the autonomous vehicle 200, designating an available autonomous vehicle 200, or searching for the autonomous vehicle 200.

The terminal may provide a user interface for requesting a personal transportation service to the user. The user interface may be a service request button or a search box or may include the search box. Alternatively, the user interface may include a device for recognizing a voice command of the user. That is, the user may request the personal transportation service to the personal transport system 100 through the voice command.

The terminal may provide the user with a search window (or a search box or search bar) to search for the autonomous vehicle 200, manage a favorite list of the autonomous vehicles 200 for the personal transportation service, and display a result for the service request of the user.

The user may search for the autonomous vehicle 200 through the search window. The user may search for the autonomous vehicles based on various criteria such as a name, a size, a type, characteristics, a style, a shape, or a color of the vehicle. The terminal may transmit search words to the personal transport system 100, receive a search result from the personal transport system 100, and display the result according to the search request of the user. For example, when the user inputs ‘black color sedan’ or ‘large SUV’ into the search window of the terminal, the terminal may display the search result corresponding to the search words input from the personal transport system 100.

In the search window, for example, at the bottom of the search word input box, the autonomous vehicle and/or autonomous driving operating system OS (or autonomous driving system, autonomous driving program, etc.) registered in the favorite list of the user may be displayed.

The search result provided from the personal transport system 100 may be a list of autonomous vehicles (for example, available autonomous vehicles) that can currently provide the personal transportation service. The list of available autonomous vehicles may be sequentially listed with matching accuracy against the criteria of the user or may be listed in the order closest to a current location or closest to the calling location of the user. The list of available autonomous vehicles may be displayed with matching accuracy and/or distance from the current location/calling location.

For example, in the list of available autonomous vehicles, the autonomous vehicle that best matches the search criteria of the user may be displayed at the top and the next autonomous vehicle with matching accuracy may be displayed sequentially. When the matching accuracy is the same, the available autonomous vehicles close to the current location or calling location may be displayed in the order in the list.

Alternatively, when the user performs the search without the search word or calls the autonomous vehicle 200 (by clicking the search button (or call button) or through the voice command), the available autonomous vehicles close to the current location or the calling location of the user may be listed in the list. When the terminal has no autonomous vehicle available, a spare or scheduled available autonomous vehicle may be sequentially displayed in the list of expected waiting times.

The terminal according to an embodiment may display the favorite list of the user. The favorite list set by the user may be stored in the user information DB 120 of the personal transport system 100 and the favorite list may include the autonomous driving OS of the autonomous vehicle and/or the autonomous vehicle.

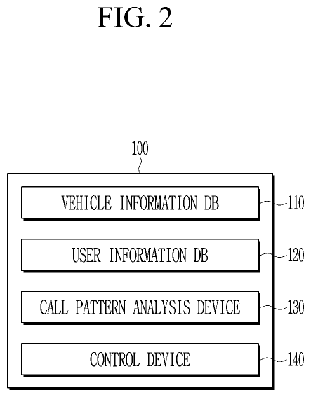

The user may select at least one autonomous vehicle 200 or the autonomous driving OS among the search results displayed in the terminal and add the selected autonomous vehicle and/or the autonomous driving OS of the autonomous vehicle to the favorite list in the user information DB 120. In addition, the user may delete the autonomous driving OS of the autonomous vehicle and/or the autonomous vehicle from the favorite list through the terminal. FIG. 2 is a drawing illustrating a personal transport system according to an embodiment.

Referring to FIG. 2, a personal transport system 100 according to an embodiment may include a vehicle information database DB 110, a user information DB 120, a call pattern analysis device 130, and a control device 140.

Vehicle information of the autonomous vehicle 200 owned by the service provider of the personal transport system 100 may be stored in the vehicle information DB 110. The vehicle information may include a vehicle registration number, a vehicle identification number VIN or a vehicle serial number. The autonomous vehicle 200 may include a two-wheeled vehicle, a three-wheeled vehicle, and a four-wheeled vehicle capable of autonomous driving.

The vehicle information may further include information to be used during autonomous driving (self-driving-related information). The self-driving-related information may include object recognition information, map information, driving route information, vehicle control information, vehicle diagnosis information, and the like. The vehicle information DB 110 may further include whether the passenger is in the vehicle and vehicle reservation information. The vehicle identification number may be an identifier uniquely assigned to each autonomous vehicle 200, such as a chassis number, and may be used for mapping with the user information DB 120.

Since self-driving-related information may be updated several times in a time interval (e.g., 1 second) during the driving of the autonomous vehicle 200, all of the self-driving-related information does not always need to be uploaded to the personal transport system 100 in real-time. However, among the self-driving-related information, information that is determined necessary for safe autonomous driving (e.g., vehicle diagnosis information, etc.) may be periodically uploaded to the personal transport system 100.

The driving route information to be used by the control unit 140 may also be periodically uploaded to the personal transport system 100. The object recognition information inside/outside the vehicle to be used for verification of the user riding in the autonomous vehicle 200 may also be uploaded.

In addition, driver information of the autonomous vehicle 200 may be stored in the vehicle information DB 110. The driver information of the autonomous vehicle 200 may include each driver's accident history, driving tendency (safety priority, speed priority, etc.). In an embodiment, the user of the autonomous driving service may select an autonomous vehicle 200 based on the driver information.

The user information DB 120 may store information necessary for the personal transport system 100 to manage users of the personal transportation service. For example, when a user subscribes to the personal transportation service, the user information DB 120 may include an ID, a personal identification number PIN, personal information (phone number, e-mail address, etc.). In an embodiment, the user information DB 120 may store a favorite list of the user. The autonomous vehicles 200 of the favorite list of the user may be mapped with the VIN of the vehicle information DB 110.

In an embodiment, the user may manage the autonomous driving OS of the autonomous vehicle and/or the autonomous vehicle in the favorite list through the terminal. The autonomous driving OS may be an operating system that controls the entire function of the autonomous vehicle or an operating system that is responsible for autonomous driving. The user may input a preferred autonomous vehicle and/or preferred autonomous driving OS to the user information DB 120 and the service provider of the personal transport system 100 may provide the personal transportation service based on the favorite list of the user. The user may manage the autonomous vehicle 200 of a predetermined number or less as the favorite list.

Users may add their preferred autonomous vehicle 200 to their favorites list or add a specific type of autonomous vehicle 200 to their favorites list. Here, the specific type may be the category of the autonomous vehicle 200 (sedan, SUV, etc.) or the model name of the autonomous vehicle 200 (GENESIS, PALISADE, etc.).

When a specific autonomous vehicle 200 is included in the favorite list, the personal transport system 100 may determine an incentive (e.g., franchising fee discounts, dividend increases) for the owners/managers of corresponding autonomous vehicle based on the number of users who added the autonomous vehicle 200 to the favorite list and the number of trips of the autonomous vehicle 200. Alternatively, when a specific user uses a specific autonomous vehicle 200 in the favorite list more than a predetermined number of times, the owner/manager of the autonomous vehicle 200 or the personal transport system 100 may provide an incentive (e.g., rate discount) to the user.

The user information DB 120 may store a call history of the autonomous vehicle 200 or a usage history of the personal transportation service. The call history of a user may include an OS, a size (light car, small, semi-medium, medium, semi-large, large, etc.), a type (sedan, SUV, wagon, hatchback, etc.), a name (model name, etc.), manufacturers (HYUNDAI, KIA, etc.), and the like.

The call pattern analysis device 130 may analyze a call pattern of the user by using machine learning technology (e.g., deep learning) based on the favorite list and the call history in the user information DB 120. Since the object recognition device 220 of the autonomous vehicle 200 can identify a user using the deep learning, the call pattern analysis device 130 may be installed on a server in which the personal transport system 100 operates, not the autonomous vehicle 200.

The call pattern analyzed by the call pattern analysis device 130 may be transmitted to the control device 140, and the control device 140 may determine waiting routes (or waiting location, mooring area) of the individual autonomous vehicle 200 based on a plurality of call patterns. Thereafter, the control device 140 may transmit information of the waiting route to each autonomous vehicle 200, and the autonomous vehicle 200 may wait for a passenger to board according to the transmitted waiting route or may moor or wander before a call.

The control device 140 may manage locations and routes of the autonomous vehicle 200 in the personal transport system 100 based on real-time traffic information collected from the autonomous vehicles 200 and may determine the waiting route of each autonomous vehicle 200 based on the calling pattern of the plurality of call pattern of the users. By preventing a large number of autonomous vehicles from being concentrated in an area where there is relatively no call history, the control device 140 may reduce an empty loaming operations of the autonomous vehicle 200 and efficiently provide the personal transportation service to the users.

The control device 140 may recommend the autonomous vehicle 200 to the corresponding user using the calling pattern of the specific user determined by the calling pattern analyzing device 130, information in the vehicle information DB 110, and information of the corresponding user in the user information DB 120. When the user does not designate a specific autonomous vehicle 200 or the autonomous vehicle 200 designated by the user cannot provide the service to the user, the control device 140 may recommend, to the user, an autonomous vehicle 200 that the user may prefer.

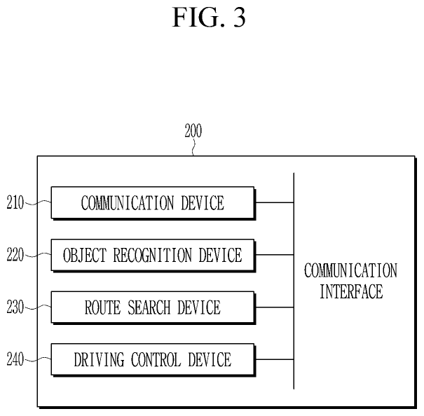

FIG. 3 is a block diagram illustrating an autonomous vehicle according to an embodiment.

Referring to FIG. 3, the autonomous vehicle 200 according to an embodiment may include a communication device 210, an object recognition device 220, a route search device 230, and a driving control device 240. The autonomous vehicle 200 may further include a communication interface between the devices.

The communication interface may transfer information received by the communication device 210 to the object recognition device 220, the route search device 230, and the driving control device 240 and may transfer information generated by the object recognition device 220, the route search device 230, and the driving control device 240 to the communication device 210. In addition, since the communication interface smoothly mediates communication between the devices included in the autonomous vehicle 200, each device in the autonomous vehicle 200 may interact stably through the communication interface.

The communication device 210 may perform communication between the autonomous vehicle 200 and the personal transport system 100 of the service provider. In addition, the communication device 210 may communicate with other vehicles outside the autonomous vehicle 200, a mobile device of a passenger, and objects on a road. The communication device 210 may receive information from the outside and transmit information to the outside using various communication standards (e.g., V2X (vehicle to everything), etc.) as well as cellular mobile communication and local area mobile communication (e.g., WiFi). Information received from the outside and information to be transmitted to the outside may go through the communication interface in the autonomous vehicle 200.

The object recognition device 220 may check the current location of the autonomous vehicle 200 through sensors (e.g., camera, radar, lidar, GPS, etc.) installed in the autonomous vehicle 200, identify objects around the autonomous vehicle, and predict the motion of the objects around autonomous vehicle. In addition, the object recognition device 220 may determine whether the user is authenticated by the personal transport system 100 by recognizing the face of the user approaching the autonomous vehicle 200 when the autonomous vehicle 200 is called.

The user may input a face information of the user into the personal transport system 100 and agree to the object recognition policy of the autonomous vehicle 200. When the user does not provide the face information, the autonomous vehicle 200 may use user information registered in the user information DB 120 to identify the user approaching the autonomous vehicle 200.

The route search device 230 may use map information of the operating area of the autonomous vehicle 200 and various sensors (GPS sensor, etc.) to wander around a predetermined area for the passenger to board or to move to a calling location by the user. Also, the route search device 230 may search for a route to a target location input by the user using the map information and the sensors and transmit the route information to the driving control device 240.

The map information may include an occupancy grid map, a positioning map, and a detailed road map. The occupancy grid map may be used to identify dynamic objects and predict the motion or behavior of the identified objects. The positioning map may be used to identify distances to nearby objects. The detailed road map may be used in a route search to a destination by the route search device 230.

In an embodiment, when the autonomous vehicle 200 updates the map information of an arbitrary area, the number of users who add the autonomous vehicle to the favorite list in the user information DB 120 in the personal transport system 100 may be considered. For example, for an area where a large number of users add the vehicle to the favorites list, the map information of the corresponding area may be updated more frequently. By determining the update of the map information according to the density of the favorite user, the autonomous vehicle 200 may efficiently approach the calling location of the user and moor/roam according to the waiting route provided by the personal transport system 100.

The driving control device 240 may control the autonomous vehicle 200 according to route information transmitted from the route search device 230. The control of the autonomous vehicle 200 may include a longitudinal direction control and a lateral direction control. The longitudinal direction control may be performed through adjustment of throttle opening and closing and adjustment of brake pressure. The lateral direction control may be performed through steering adjustment.

The driving control device 240 may control the autonomous vehicle 200 according to a driving manner selected by the user. For example, when the user inputs comfortable driving manner as the driving manner, the driving control device 240 may control the autonomous vehicle 200 so that the user can feel comfortable. Alternatively, when the user inputs sporty driving manner as the driving manner, the driving control device 240 may control the autonomous vehicle 200 so that the user can feel speed as quickly as possible within the traffic regulations of the road.

When driving to the destination, the driving control device 240 may consider not only the route information to the destination but also the instruction received from the personal transport system 100 and adjust the driving speed, driving lane, etc. by identifying surrounding objects in real-time.

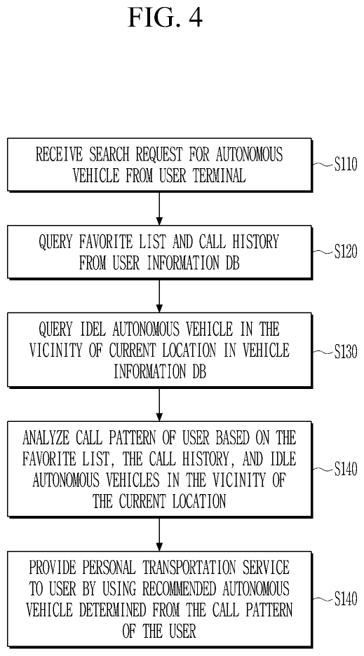

FIG. 4 is a flowchart illustrating a method for providing a personal transportation service through an autonomous vehicle according to an embodiment.

In an embodiment, when the user searches for the autonomous vehicle 200 through the terminal, the personal transport system 100 may provide a search result to the user. Afterwards, when the user selects the autonomous vehicle 200 from the search result through the terminal, the personal transportation service may be provided to the user through the autonomous vehicle 200 selected by the user.

In an embodiment, when the user requests the use of the autonomous vehicle 200 in the favorite list through the terminal, the personal transport system 100 may check the availability of the requested autonomous vehicle 200 and notify the user of the availability of the autonomous vehicle 200. When the autonomous vehicle 200 in the favorite list selected by the user is available, the personal transport system 100 may provide the personal transportation service to the user through the autonomous vehicle 200.

However, when the autonomous vehicle 200 selected by the user is not available or the user requests a search for the autonomous vehicle 200, the personal transport system 100 may provide the user with at least one recommended autonomous vehicle 200.

Referring to FIG. 4, when the user requests a search for the autonomous vehicle 200 through the terminal (S110), the call pattern analysis device 130 of the personal transport system 100 can query the favorite list and the call history of the user in the user information DB 120 (S120).

The favorite list of the user may include a list of the autonomous vehicle 200 predetermined by the user and/or a list of the autonomous driving OS of the autonomous vehicle 200. The call history of the user may include the OS, size (light car, small, semi-medium, medium, semi-large, large, etc.), type (sedan, SUV, wagon, hatchback, etc.), name (model name, etc.)), manufacturers (Hyundai, Kia, etc.), and the like.

The call pattern analysis device 130 of the personal transport system 100 may query the autonomous vehicle 200 in the vicinity of the current location of the user in the vehicle information DB 110 (S130). When the user searches for the autonomous vehicle 200 and inputs a calling location other than the current location, the calling pattern analysis device 130 may query the autonomous vehicle 200 in the vicinity of the calling location. The autonomous vehicle 200 in the vicinity of the current location/calling location of the user may be an idle vehicle with no passengers or a scheduled idle vehicle from which a passenger will soon get off at the current location/calling location or around the locations.

The call pattern analysis device 130 of the personal transport system 100 may analyze the call pattern of the user based on the favorite list and call history and the list of idle vehicles (including scheduled idle vehicles) (S140). The call pattern analysis device 130 may input the favorite list, the call history, and the idle vehicle list to the pre-trained artificial intelligence AI model, and the pre-trained AI model may output the call pattern of the user or at least one recommended autonomous vehicle.

The personal transport system 100 may determine the at least one recommended autonomous vehicle according to the calling pattern of the user and provide the at least one recommended autonomous vehicle to the user as the search result. Thereafter, when the user selects at least one recommended autonomous vehicle 200, the personal transport system 100 may provide the personal transportation service to the user by using the selected autonomous vehicle 200 (S150). Afterwards, when the user selects at least one recommended autonomous driving vehicle 200, the personal transportation system 100 may provide the personal transportation service to the user by using the selected autonomous driving vehicle 200.

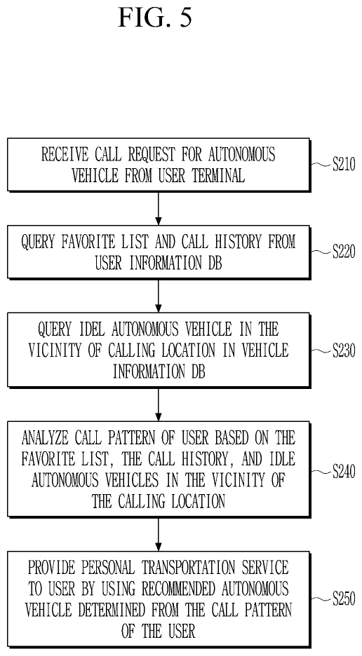

FIG. 5 is a flowchart illustrating a method for providing a personal transportation service through an autonomous vehicle according to another embodiment.

In another embodiment, when a user requests a call of the autonomous vehicle 200 through the terminal, the personal transport system 100 may analyze the call history and call pattern of the user to allocate an optimal autonomous vehicle 200 and immediately provide the personal transportation service.

Referring to FIG. 5, when a call request for the autonomous vehicle 200 is received from the terminal (S210), the call pattern analysis device 130 of the personal transport system 100 may query the favorite list and the call history of the user in the user information DB 120 (S220).

The favorite list of the user may include a list of autonomous vehicles 200 predetermined by the user and/or a list of autonomous driving OSs of the autonomous vehicle 200. The call history of the user may include the OS, size (light car, small, semi-medium, medium, semi-large, large, etc.), type (sedan, SUV, wagon, hatchback, etc.), name (model name, etc.)), manufacturers (Hyundai, Kia, etc.), and the like.

The call pattern analysis device 130 of the personal transport system 100 may query the autonomous vehicle 200 in the vicinity of the calling location of the user in the vehicle information DB 110 (S230). The autonomous vehicle 200 in the vicinity of the calling location of the user may include an idle vehicle with no passengers and/or a scheduled idle vehicle from which a passenger will soon disembark in the calling location.

The call pattern analysis device 130 of the personal transport system 100 may analyze the call pattern of the user based on the favorite list and call history and the list of idle vehicles (including scheduled idle vehicles) (S240). The call pattern analysis device 130 may input the favorite list, the call history, and the idle vehicle list to the pre-trained AI model, and the pre-trained AI model may output the call pattern of the user or at least one recommended autonomous driving Vehicle 200.

Thereafter, the personal transport system 100 may provide the personal transportation service to the user using the autonomous vehicle 200 determined according to the call pattern of the user (S250).

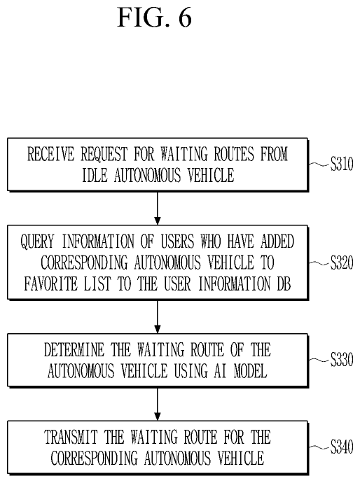

FIG. 6 is a flowchart illustrating a method for determining a waiting route of an autonomous vehicle according to an embodiment.

In an embodiment, each autonomous vehicle 200 may request a waiting route from the personal transport system 100 while the passenger disembarks and there is no call received. The personal transport system 100 may determine a waiting route of each autonomous vehicle 200 based on a current location of each autonomous vehicle 200 and an analysis result of a plurality of call patterns of the user.

Referring to FIG. 6, when a request for a waiting route is received from an idle vehicle or a scheduled idle vehicle, (S310), the call pattern analysis device 130 of the personal transport system 100 may query information of all users who have added corresponding autonomous vehicle 200 to the favorite list to the user information DB 120 (S320). In some embodiments, the request for the waiting route may be generated by the idle vehicle from which the passenger had been disembarked or the scheduled idle vehicle for which the passenger are expected to disembark soon or the personal transport system 100 that monitors the disembark of the passenger.

The user information to be used by the call pattern analysis apparatus 130 to analyze the call pattern of the user may include the call history of the user, boarding history of the user, and the like. The user information may not include information that can uniquely distinguish the user, such as the user's ID, secret number, and personal information.

The call pattern analysis device 130 may input the information of the user and the current location of the autonomous vehicle 200 to the AI model modeled through machine learning such as deep learning and determine the waiting route for each autonomous vehicle 200 from the output of the AI model (S330). Thereafter, the personal transport system 100 may transmit the waiting route for each autonomous vehicle 200 to the corresponding autonomous vehicle 200 (S340). In an embodiment, the waiting route may include a specific movement route of the autonomous vehicle 200 or a range of a mooring area.

The autonomous vehicle 200 may wait for a call from a user by controlling the vehicle with reference to the transmitted waiting route. The autonomous vehicle 200 may refer to the map information and information collected by the object recognition device 220 when driving along the waiting route. Alternatively, the route search device of the autonomous vehicle 200 may modify the real-time waiting route based on the transmitted waiting route, the map information, and the information collected by the object recognition device 220.

As described above, in a personal transportation service using an autonomous vehicle, the call pattern of the user for the vehicle can be analyzed based on the favorites of the autonomous vehicle or the autonomous driving operating system of the autonomous vehicle, so that the autonomous vehicle can efficiently provide the personal transportation service using less fuel, and thus idle vehicles can be minimized.

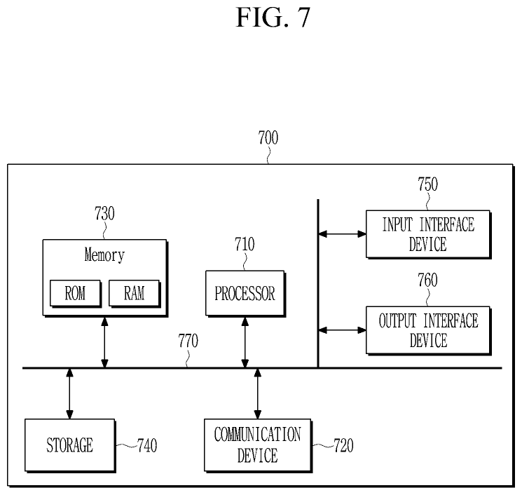

FIG. 7 is a block diagram illustrating a personal transport system according to another embodiment.

The personal transport system according to an embodiment may be implemented as a computer system, for example, a computer-readable medium. Referring to FIG. 7, the computer system 700 may include at least one of a processor 710, a memory 730, an input interface device 750, an output interface device 760, and a storage device 740 communicating through a bus 770. The computer system 700 may also include a communication device 720 coupled to the network. The processor 710 may be a central processing unit (CPU) or a semiconductor device that executes instructions stored in the memory 730 or the storage device 740. The memory 730 and the storage device 740 may include various forms of volatile or nonvolatile storage media. For example, the memory may include read only memory (ROM) or random-access memory (RAM). In the embodiment of the present disclosure, the memory may be located inside or outside the processor, and the memory may be coupled to the processor through various means already known. The memory is a volatile or nonvolatile storage medium of various types, for example, the memory may include read-only memory (ROM) or random-access memory (RAM).

Accordingly, the embodiment may be implemented as a method implemented in the computer, or as a non-transitory computer-readable medium in which computer executable instructions are stored. In an embodiment, when executed by a processor, the computer-readable instruction may perform the method according to at least one aspect of the present disclosure.

The communication device 720 may transmit or receive a wired signal or a wireless signal.

On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like.

Program instructions may include machine language code such as those produced by a compiler, as well as high-level language code that may be executed by a computer via an interpreter, or the like.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software. The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages, and may be deployed in any form including a stand-alone program or a module, a component, a subroutine, or other units suitable for use in a computing environment.

A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks.

Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium.

A processor and a memory may be supplemented by, or integrated into, a special purpose logic circuit. The processor may run an operating system 08 and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements.

For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination.

Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

While this disclosure has been described in connection with what is presently considered to be practical example embodiments, it is to be understood that this disclosure is not limited to the disclosed embodiments.

On the contrary, it is intended to cover various modifications and equivalent arrangements included within the spirit and scope of the appended claims.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A personal transport system, comprising:
a processor, a memory, and a communication device, wherein the processor executes a program stored in the memory to perform:
receiving a request for a personal transportation service using an autonomous vehicle from a terminal of a user;
analyzing a call pattern of the user for the autonomous vehicle; and
determining a recommended autonomous vehicle to provide the personal transportation service to the user based on the analysis result of the call pattern.

2. The system of claim 1, wherein
when the processor performs the analyzing a call pattern of the user for the autonomous vehicle, the processor performs:
querying a call history of the user and an idle autonomous vehicle around a call location of the user; and
analyzing the call pattern based on the call history and the idle autonomous vehicle.

3. The system of claim 2, wherein
when the processor performs the analyzing a call pattern of the user for the autonomous vehicle, the processor further performs
querying a favorite list of the user for the autonomous vehicle, and
wherein the favorite list includes an autonomous vehicle and/or an autonomous driving operating system for the autonomous vehicle preferred by the user.

4. The system of claim 3, wherein
when the processor performs the analyzing the call pattern based on the call history and the idle autonomous vehicle around the call location, the processor performs
analyzing the call pattern based on the favorite list, the call history, and the idle autonomous vehicle around the call location.

5. The system of claim 1, wherein
when the processor performs the receiving a request for a personal transportation service using an autonomous vehicle from a terminal of a user, the processor performs
receiving a search request for an autonomous vehicle from the terminal, and
wherein the search request includes at least one of a name, a size, a type, characteristics, a style, a shape, and a color of the autonomous vehicle.

6. The system of claim 1, wherein
the processor executes the program to further perform
transmitting at least one available autonomous vehicle to the terminal in response to the search request, and
wherein the at least one available autonomous vehicle is listed in an order of matching accuracy for search criteria of the user or in an order close to a current location or the calling location of the user.

7. The system of claim 1, wherein
the processor executes the program to further perform
determining a waiting route for each autonomous vehicle based on the analysis result of the call pattern.

8. The system of claim 7, wherein
the processor executes the program to further perform:
receiving a request for the waiting route from an idle autonomous vehicle without a passenger and within which no call has been received; and
transmitting the waiting route determined based on the analysis result of the call pattern to the idle autonomous vehicle.

9. The system of claim 1, wherein
the recommended autonomous vehicle includes an idle vehicle with no passengers or a scheduled idle vehicle for which a passenger is about to disembark.

10. A method for providing a personal transportation service using an autonomous vehicle, the method comprising:
receiving a request for the personal transportation service from a terminal of a user;
analyzing a call pattern of the user for the autonomous vehicle; and
determining a recommended autonomous vehicle to provide the personal transportation service to the user based on the analysis result of the call pattern.

11. The method of claim 10, wherein
the analyzing of the call pattern comprises:
querying a call history of the user and an idle autonomous vehicle around a call location of the user; and
analyzing the call pattern based on the call history and the idle autonomous vehicle.

12. The method of claim 11, wherein
the analyzing of the call pattern further comprises:
querying a favorite list of the user for the autonomous vehicle, and
wherein the favorite list includes an autonomous vehicle and/or an autonomous driving operating system of the autonomous vehicle preferred by the user.

13. The method of claim 12, wherein
the analyzing the call pattern based on the call history and the idle autonomous vehicle comprises:
analyzing the call pattern based on the favorite list, the call history, and the idle autonomous vehicle.

14. The method of claim 10, wherein
the receiving the request for the personal transportation service comprises
receiving a search request for an autonomous vehicle from the terminal, and
wherein the search request includes at least one of a name, a size, a type, a characteristics, a style, a shape, and a color of the autonomous vehicle.

15. The method of claim 10, further comprising:
transmitting at least one available autonomous vehicle to the terminal in response to the search request, and
wherein the at least one available autonomous vehicle is listed in an order of matching accuracy for search criteria or in an order close to a current location or the calling location of the user.

16. The method of claim 10, further comprising
determining a waiting route for each autonomous vehicle based on the analysis result of the call pattern.

17. The method of claim 16, further comprising:
receiving a request for the waiting route from an idle autonomous vehicle without a passenger and within which no call has been received; and
transmitting the waiting route determined based on the analysis result of the call pattern to the idle autonomous vehicle.

18. The method of claim 10, wherein
the recommended autonomous vehicle includes an idle vehicle without a passenger or a scheduled idle vehicle for which a passenger is expected to disembark.
